(19) United States
(12) Patent Application Publication
(10) Pub. No.: US 2004/0133612 A1
(43) Pub. Date: Jul. 8, 2004

(54) Information processing system which performs data keeping service, information processing apparatus, kept information management method

(75) Inventor: Hiroshi Satomi, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/737,969

(22) Filed: Dec. 18, 2003

(30) Foreign Application Priority Data
Dec. 27, 2002 (JP) 2002-382492

(51) Int. Cl. G06F 12/00

(52) U.S. Cl. 707/205

(57) ABSTRACT

There is provided a method of keeping data in an information processing apparatus connected to a network. In this method, the upper limit of the amount of data that can be kept in a first storage area is set, the apparatus indicates to delete kept data after the apparatus has kept the new data in a second storage area in accordance with a result of comparison between the upper limit of the amount of data that can be kept with the sum of the data amount of data kept in the first storage area and the data amount of the new data. In deletion indication operation, the apparatus provides a plurality of choices including deletion of kept data by a data amount exceeding the upper limit after the apparatus has kept the new data, and when the apparatus indicates to delete kept data by the amount exceeding the upper limit after the apparatus has kept the new data, the apparatus inhibits performing operations other than data deletion. With this arrangement, there can be provided a data keeping service which, when data exceeding the upper limit of the amount of data is to be kept, temporarily keeps the data, and deletes unnecessary data.

### FIELD OF THE INVENTION

The present invention relates to a data keeping service and, more particularly, to an information processing system which can, for example, keep digital image data held by a user on a server connected by using a communication environment such as the Internet, and place a print order, an information processing apparatus, a kept information management method, a storage medium in which a program for executing the method is stored so as to be read out by the information processing apparatus, and the program.

### BACKGROUND OF THE INVENTION

A network service is available, as a kind of information providing service via a network such as Internet, which keeps the digital image data photographed by a user using an input device in a storage area of a server on a network and allows the user to browse the digital image data as the user wishes. There is also available a network service which provides a service of disclosing kept digital image data to the third party designated by a user. A provider who provides such a network service will be referred to as a photo site hereinafter.

With improvements in the Internet environment, especially the proliferation of high-speed lines in general homes, and the widespread use of high-quality digital cameras, the file size of digital image data uploaded to photo sites has greatly increased. If, therefore, all user images are to be kept for a long period of time, the image database in a photo site becomes enormous. As a consequence, a service manager requires a considerable system maintenance cost for the installation of additional disks and the like. In order to suppress an increase in this maintenance cost, a system manager in such a photo site sometimes imposes predetermined limitations on service users to inhibit each user from uploading an image file exceeding a predetermined amount.

Some of the users of such network photo services has uploaded image data up to a provided limitation. When such a user is to further upload image data, the user cannot upload new image data unless the user deletes unnecessary image data or the like by himself/herself upon accessing the photo site.

Some user tries to upload image data without checking the remaining capacity to the limit amount of data that can be kept. In the process of transferring a file, such a user finds that image data to be uploaded exceeds the upper limit of data that can be kept, and must cancel the uploading processing. In this case, the user must pay the communication charge for the uploading operation even if the uploading operation fails.

Note that the above problem is not limited to network photo services but is common to systems designed to keep data through networks.

### SUMMARY OF THE INVENTION

The present invention has been proposed to solve the problems in the prior art, and has as its object to provide a data keeping service which permits a user who tries to keep data exceeding the upper limit of the amount of data that can be kept to temporarily keep the data, and allows him/her to delete unnecessary data afterward, an information processing system for the service, an information processing apparatus, a method of managing kept information, a storage medium in which a program for executing the method is stored so as to allow the information processing apparatus to read out, and the program.

In order to achieve the above object, according to the present invention, there is provided a method of keeping data in a data keeping service of keeping data in an information processing apparatus connected to a network, comprising the steps of setting an upper limit of the amount of data that can be kept in a first storage area, and indicating a user to delete kept data after the apparatus has kept new data in a second storage area, in accordance with a result of comparison between the upper limit of the amount of data with a sum of a data amount of data kept in the first storage area and a data amount of the new data.

In this case, the indication step includes the steps of providing the user with a plurality of choices including deletion of kept data by a data amount exceeding the upper limit after keeping the new data, and inhibiting the user from performing operations other than data deletion when indicating the user to delete kept data by the amount exceeding the upper limit after keeping the new data. The plurality of choices include keeping data after deleting at least an old file in the data amount of the new data to be kept, and stopping keeping data. The old file is selected on the basis of a creation date/time or access date/time. The upper limit of the amount of data is set periodically or when new data is kept or kept data is accessed. The upper limit of the amount of data is set in accordance with an amount billed for the use of the data keeping service and an associated service. The associated service includes printing processing of the kept data. The kept data includes image data.

In addition, there is provided an information processing apparatus which keeps data from an entity connected to a network into a storage area, comprising an upper limit amount setting unit adapted to set an upper limit of the amount of data that can be kept for the entity, a discrimination unit adapted to discriminate whether a sum of a data amount of data from the entity that has already kept and a data amount of data from the entity to be newly kept exceeds the upper limit of the amount of data, and a deletion indication unit adapted to, when a discrimination result indicates that the sum exceeds the upper limit of the amount of data, indicate the entity to delete kept data by a data amount exceeding the upper limit after the apparatus has kept the new data.

Furthermore, there is provided an information processing apparatus which is connected via a network to a server keeping data into a storage area, comprising an upper limit amount receiving unit adapted to receive an upper limit of the amount of data that can be kept, a discrimination unit adapted to discriminate whether a sum of a data amount of data that has already kept and a data amount of data to be newly kept exceeds the upper limit of the amount of data, a choice providing unit adapted to provide a plurality of choices including deleting kept data by a data amount exceeding the upper limit after the apparatus has kept the new data, when a discrimination result indicates that the sum exceeds the upper limit of the amount of data, and an inhibiting unit adapted to inhibit performing operation other than data deletion, when the apparatus indicates to delete kept data by a data amount exceeding the upper limit after the apparatus has kept the new data.

According to the present invention, there can be provided a data keeping service which allows deletion of kept image data even after image data exceeding the upper limit of the disk capacity that can be used, an information processing system for the service, an information processing apparatus, a method of managing kept information, a storage medium in which a program for executing the method is stored so as to be read out by the information processing apparatus, and the program.

That is, there are provided an information processing system which permits a user who tries to keep data exceeding the upper limit of the amount of data that can be kept to temporarily keep the data, and allows him/her to delete unnecessary data afterward, an information processing apparatus, a method of managing kept information, a storage medium in which a program for executing the method is stored so as to allow the information processing apparatus to read out, and the program.

In addition, there are provided an information processing system which notifies a user who tries to keep data exceeding the upper limit of the amount of data that can be kept that the data exceeds the upper limit, and allows the user to choose between canceling keeping the data, automatically deleing past kept data, and manually deleting kept data afterward, an information processing apparatus, a method of managing kept information, a storage medium in which a program for executing the method is stored so as to allow the information processing apparatus to read out, and the program.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram showing an example of the schematic arrangement of a data keeping service system according to an embodiment of the present invention;

FIG. 2 is a view showing an image information table 200 in which information about each image stored in an information DB 118 of a photo site 105 is stored according to this embodiment;

FIG. 3 is a view showing an album information table 300 in which information about an album stored in the information DB 118 of the photo site 105 is stored according to this embodiment;

FIG. 4 is a view showing a user information table 400 stored in the information DB 118 of the photo site 105 according to this embodiment;

FIG. 5 is a view showing the contents of a billing information table 500 which is used by a system in a photo site according to this embodiment;

FIG. 6 is a view showing an order information table 600 associated with the photo site 105 according to this embodiment;

FIG. 7 is a view showing an album editing window 700 which is displayed when a user logs in to a photo site according to this embodiment;

FIG. 8 is a view showing an example of a user information setting window 800 in the photo site 105 according to this embodiment;

FIG. 9 is a view showing an example of a use status check window 900 for a user terminal in the photo site 105 according to this embodiment;

FIG. 10 is a view showing an image upload window 1000 in this embodiment;

FIG. 11 is a flow chart showing an upload processing sequence in the photo site 105 according to this embodiment;

FIG. 12 is a view showing a warning window 1200 at the time of uploading image data in this embodiment;

FIG. 13 is a view showing a warning window 1300 which is displayed when a user who has kept image data exceeding the upper limit of the disk capacity that can be used tries to perform operation other than deletion in the photo site 105 in this embodiment;

FIG. 14 is a view showing a print order window 1400 in this embodiment;

FIG. 15 is a view showing the format of data to be sent when the photo site 105 notifies a print site 109A of the start of a print order in this embodiment;

FIG. 16 is a view showing the format of data to be sent to make the photo site 109A notify the photo site 105 of estimate display information in this embodiment;

FIG. 17 is a view showing the format of data to be sent when the photo site 105 places a format print order to the print site, 109A in this embodiment;

FIG. 18 is a flow chart showing a processing sequence for placing a format print order in the photo site 105 in this embodiment;

FIG. 19 is a flow chart showing a sequence for calculating the maximum disk capacity that can be used in the photo site 105 in this embodiment; and

FIG. 20 is a flow chart showing processing at the time of login to a photo site in this embodiment.

### DETAILED DESCRIPTION OF THE PREFERRED EMBODIMENTS

The preferred embodiments of the present invention will be described exemplarily in detail with reference to the accompanying drawings. Note that the scope of the present invention is not limited to only the relative positions of the constituent elements, the display windows, and the like described in the embodiments unless otherwise specified. As an information providing system, a system which provides print services will be representatively described below. However, as described above, the present invention is not limited to this and is directed to solve problems common to services using networks, and hence also incorporates systems which solve such problems.

<Examples of Arrangement and Basic Operation of Information Providing System of Embodiment>

An information providing system which shares and provides digital image data through the Internet as a network will be described as an embodiment of the present invention.

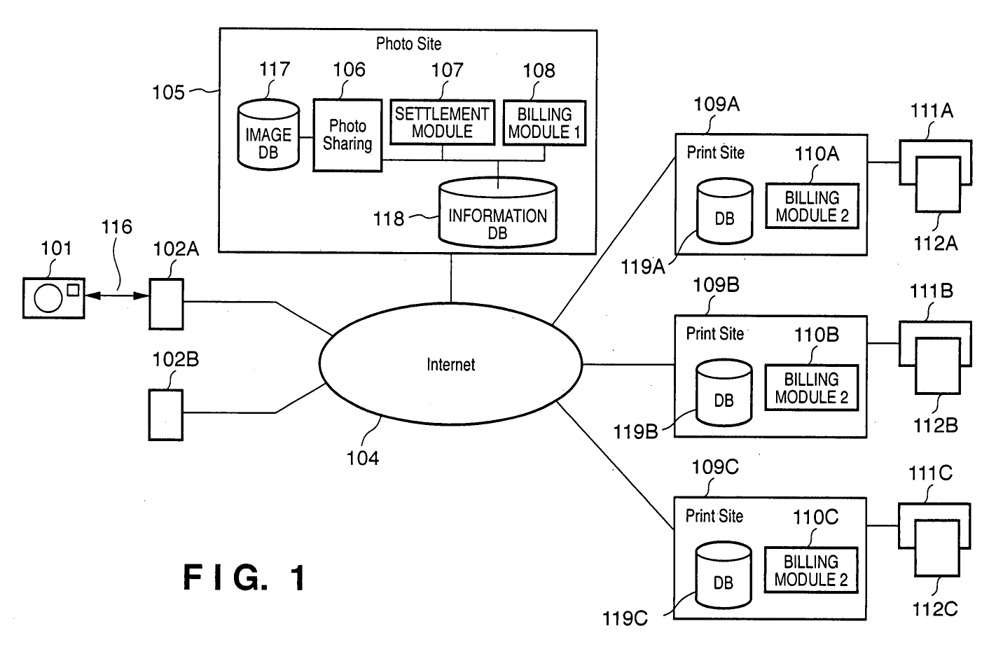

FIG. 1 shows the overall system which provides services in this embodiment. In the following description, a party who has kept image data will be simply referred to as a user; and a third party, as a browsing user.

(Example of Acquiring Image Data)

Reference numeral 101 denotes image input equipment such as a digital still camera which can photograph a still image and record it as image data or a digital video camera which can sense a moving image and record it as moving image data, i.e., an apparatus which converts an optical image as image information into an electrical signal, performs predetermined image processing for the signal, and records/reproduces it as digital information; 102A, a user personal computer (to be abbreviated to a user PC hereinafter); and 116, a data transfer interface for transferring photographed image data between the image input apparatus 101 and the user PC 102A. The data transfer interface 116 may be a wire interface typified by USB or IEE1394 or a wireless interface typified by IrDA or Bluetooth.

The image data photographed by the image input apparatus 101 and stored as digital information is transferred to a storage area of an information storage unit typified by the HDD of the user PC 102A through the data transfer interface 116. Image data are transferred from the image input apparatus 101 to the user PC 102A either by the following two procedures: transferring all the image data stored in the information storage unit in the image input apparatus 101 at once in accordance with an instruction from the OS or dedicated software installed in the user PC 102A; and causing the OS or dedicated software in the user PC 102A to ensure a data recording area in the information recording unit of the user PC 102A, and transferring image data in accordance with a transfer command sent from the image input apparatus 101.

(Example of Uploading Image Data)

The image data transferred to the user PC 102A in this manner is uploaded to a photo site 105 connected to the Internet 104 according to the following procedure.

A browser which operates on the user PC 102A and has a standard protocol capable of information transfer on the Internet 104 accesses the photo site 105 by using a standard protocol such as the http protocol to display information linked to multimedia information such as image information and sound information created by a description language such as HTML or XML and managed by a server PC on the photo site 105. This operation allows the user PC 102A to receive services which use the Internet 104 as a communication infrastructure and are provided by the photo site 105.

The image data photographed by the image input apparatus 101 and stored in the information storage area of the user PC 102A is transferred to the photo site 105 in accordance with a request from the user of the user PC 102A (this transfer will be referred to as image uploading hereinafter). Image uploading includes a case wherein image data to be transferred is selected from the above browser and transferred in response to a request action for image uploading, and a case wherein image data is selected using software dedicated to image uploading or the like and directly transferred from the above software dedicated to image uploading. In either case, image uploading is executed on the basis of a protocol that can be used on the Internet, such as http or ftp. A photo sharing module 106 is a module which executes this series of operations.

The photo sharing module 106 checks whether the uploaded image data is data which can be used by the photo site 105. Upon determining that the data can be used, the photo sharing module 106 stores the uploaded image data in an image database 117, and stores its attribute information and the like in a database 118. At this stage, the photo sharing module 106 notifies the user PC 102A that the image data is normally uploaded.

In addition to the above attribute information of image data, the following data are unitarily managed in the database 118: data of user attribute information registered in the photo site 105, attribute information about a print service provider (to be referred to as a print site hereinafter) to whom a request to print out uploaded image data is issued, and the like. The user of the user PC 102A can browse images of the image data uploaded in this manner which are designated through the browser. In this browsing operation, uploaded image data may be managed on an album basis with each album being constituted by a plurality of frames.

In this embodiment, as will be described in detail below, the upper limit of the amount of data that can be kept is set for each user, and it is checked in uploading operation whether the upper limit will be exceeded, thereby properly performing uploading processing.

(Example of Printing Image Data)

The flow of placing a print order for uploaded image data will be sequentially described next. The user of the user PC 102A can browse image data, of the image data uploaded to the photo site 105, which are uploaded by himself/herself through the browser. At this time, images to be browsed are selected in the following manner. The user sequentially selects images to be browsed on by one. Alternatively, a plurality of frames are registered as one album, and the user selects one of a plurality of albums which the user wants to browse. The user then selects and browses each image managed in the selected album.

The photo site 105 entrusts the print order for the image data uploaded from the user to a print site which provides a printout of image data as a solution. Such print providers include print sites 109A, 109B, and 109C. For the sake of illustrative convenience, FIG. 1 shows only the three print sites. However, the system may include more print sites, and the number of print sites is not limited.

The user of the user PC 102A selects image data which the user wants to print out and obtain as merchandise from the browse window of the uploaded image data. The user of the user PC 102A then selects a print site to which the user wants to place an order from the print sites 109A, 109B, and 109C which can be provided by the photo site 105. The user selects a print site to which the user will place an order, in consideration of the services, prices, delivery dates, and the like offered by the respective print sites. For the sake of descriptive convenience, assume that the user has selected the print site 109A. However, the basic flow of information remains the same regardless whether the user selects the print site 109B or print site 109C.

The user who wants to place a print order selects image data for which the user wants to place a print order from a browse window, and notifies the photo site 105 of the corresponding information. The photo site 105 generates a temporary print order concerning the image data for which the printout request has been issued, and issues an estimation request to the print site 109A through the Internet 104. Upon receiving the temporary print order from the photo site 105, the print site 109A causes a billing module 110A as a billing means to calculate a price in accordance with the contents of the temporary print order, and notifies the photo site 105 of the estimated amount through the Internet 104. The photo site 105 can receive this estimated amount information in real time and transfer its information to the user PC 102A, thereby dynamically presenting the user who has placed the print order the price presented by the print site 109A.

If the user of the user PC 102A who has placed the print order gives his/her approval to the purchase at the offered price and returns an approval action to the photo site 105, a settlement module 107 accepts it and performs settlement processing. When the settlement is complete, the photo site 105 sends a formal print order to the print site 109A. Upon accepting this formal print order, the print site 109A acquires image data required for printout operation from the database in the photo site 105. The image data acquired in this manner is printed out by a printing means 111A owned by the print site 109A and output as printed matter 112A. Some kind of transportation means then delivers the printed-out printed matter 112A to the address for delivery designated by the user of the user PC 102A, who has issued the printout request.

The above brief description covers the system for allowing the user, who has uploaded the image data photographed by the image input apparatus 101, to browse the photo site 105 and place a print order through the user PC 102A. Although the PC has been exemplified as a terminal which uploads images, the information providing system according to the present invention is not limited to this. Images may be uploaded from portable terminals or may be directly uploaded from image input apparatuses such as digital cameras, digital videos, scanners, and copying machines.

(Example of Browse Processing for Third Party)

A method will be described next, which allows a person other than the user who has uploaded image data to the photo site 105 to browse, through the Internet 104, the image data uploaded to the photo site 105 and stored in the image database 117. The photo site 105 provides a third party designated by the user who has uploaded image data with browse and print order services for an “uploaded image” or an “album managing a plurality of uploaded images as one archive”.

The user who has uploaded image data to the photo site 105 notifies, through a Web browser 120A, the photo site 105 of attribute information such as the name of a user who is permitted to browse (to be abbreviated to a browse user hereinafter) and his/her e-mail address. In disclosing an image to the browse users, the photo site 105 creates first a URL (Universal Resource Locator) required for disclosure. As a URL to be created at this time, a unique address using a uniquely unpredictable random number of the like is assigned. The following is an example of such an address:

http://◯◯◯.com/PhotoSite/Album/AlbumEntry.cgi?A lbumID=AJNWDMF (Such an uniquely unpredictable URL will be a random URL hereinafter.)

The photo site 105 e-mails the browse user with a random URL created in this manner through the Internet 104 upon adding password information necessary for browsing as needed. Upon receiving the e-mail, the browse user accesses the Internet 104 from a user PC 102B to input the random URL e-mailed to a Web browser 120B. This allows the browse user to browse the image or album designated by the user who has uploaded the image data.

(Example of How User Places Print Order)

A method will be described next, which allows the browse user of the user PC 102B to place a print order for the image data which are made browsable in this manner. The photo site 105 sends the print order for image data from the browse user to one of the print sites 109A, 109B, and 109C which provide image data printout services.

The browse user of the user PC 102B selects, from the browse window, image data which the user wants to print out and obtain printed matter as merchandise. The browse user of the user PC 102B selects a print site 109, to which the user wants to place an order, from the print sites 109A, 109B, and 109C which can provided by the photo site 105. The browse user selects the print site 109, to which the user places an order, in consideration of the services, unit prices, delivery dates, and the like offered by the respective print sites 109. For the sake of descriptive convenience, assume that the user has selected the print site 109B. However, the basic flow of information remains the same regardless whether the user selects the print site 109A or print site 109C. A description of this operation will therefore be omitted.

When the browse user selects, from the browse window, image data for which the user wants to place a print order, and notifies the photo site 105 of the corresponding information, the photo site 105 generates a temporary print order concerning the image data for which the printout request has been issued, and transmits the order to the print site 109B through the Internet 104, thereby requesting the print site 109B to make an estimate. Upon receiving the temporary print order from the photo site 105, the print site 109B acquires image data necessary for selection image information from the image database 117 of the photo site 105, and generates selection image information. Transmitting this selection image information to the user PC 102B through the Internet 104 allows the browse user to input a print form, the number of copies, and the like for each image selected on the Web browser 120B by using the user PC 102B.

The print site 109B causes a charge calculating (billing) module 110B to calculate an estimated amount for each selected image on the basis of the information such as the print form and the number of copies. The print site 109B transmits the calculated estimated amount to the photo site 105 through the Internet 104. The photo site 105 receives the information of the estimated amount transmitted from the print site 109B in real time. If the browse user does not have the personal information of the user, the estimated amount transmitted from the print site 109B is transferred as Web information to the user PC 102B. If the browse user has the personal information of the user, the offered amount obtained by adding a point to the estimated amount is transferred as Web information. In this manner, the estimate information can be dynamically presented to the browse user who has placed the print order.

If the browse user of the user PC 102B who has placed the print order gives his/her approval to the purchase at the offered price and returns an approval action to the photo site 105, the settlement module 107 as a settlement means accepts it and performs settlement processing. When the settlement is complete, the photo site 105 sends a formal print order to the print site 109B. Upon accepting this formal print order, the print site 109B acquires image data required for printout operation from the image database 117 of the photo site 105. The image data acquired in this manner is printed out by a printer 111B serving as printing means owned by the print site 109B and output as printed matter 112B. Some kind of transportation means then delivers the printed-out printed matter 112B to the browse user of the user PC 102B, who has issued the printout request.

The above brief description covers the information providing system for allowing a user as a third party, who has received a permission to browse an image or album from a user who has uploaded image data, to browse the image data and place a print order on the basis of the information received from the photo site 105.

<Example of Arrangement of Photo Site in Information Providing System of Embodiment>

Processing will be described in detail below, which is to be performed by the above information providing system at the time of registration of image data when the size of data to be kept is determined in uploading the image data, and the size exceeds the upper limit of the amount of data that can be kept. Note that the services and functions realized by the system of this embodiment are not limited to those in the above brief description.

(Examples of Arrangements of Tables)

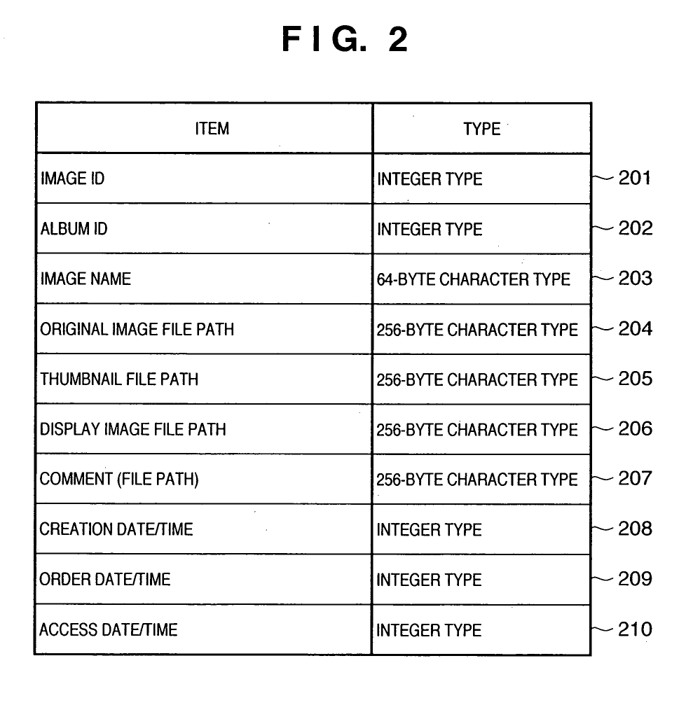

FIG. 2 is a view showing an image information table 200 which stores information about each image stored in the information DB 118 of the photo site 105 in this embodiment.

In this embodiment, each image has an image ID 201, an album ID 202 to which the image belongs, a title (image name) 203 assigned to the image, a file path 204 to the original image on the image DB 117, a file path 205 to a thumbnail image displayed on the Web, a file path 206 to an image for detailed display on the Web, a comment 207 set for the image by the owner, a date/time 208 when the image was created (uploaded), a date/time 209 when the latest print order was placed, and a date/time 210 of the latest access to the image data. Assume that in this embodiment, user images are managed one by one or for each group (album) of a plurality of images. In this embodiment, the dates/times indicated by the dates/times 208 to 210 are held as the total numbers of seconds counted from Jan. 1, 1970, 0:0:0 a.m. regarded as “0”. However, any date/time form can be used as long as each date/time can be specified. Note that the above dates/times are used for determination of deletion of image data in chronological order,-but are not limited to the dates/times 208 to 210.

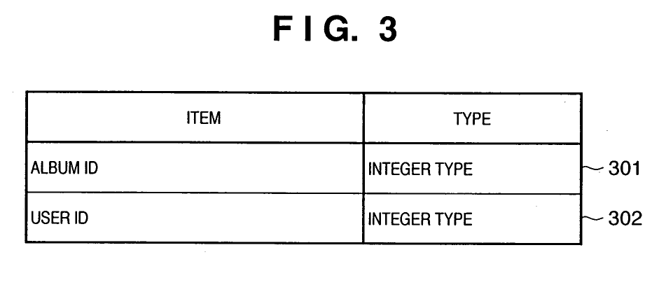

FIG. 3 is a view showing an album information table 300 stored in the information DB 118 of the photo site 105 in this embodiment.

The album information table 300 has an album ID 301 and a user ID 302 of the owner of the album.

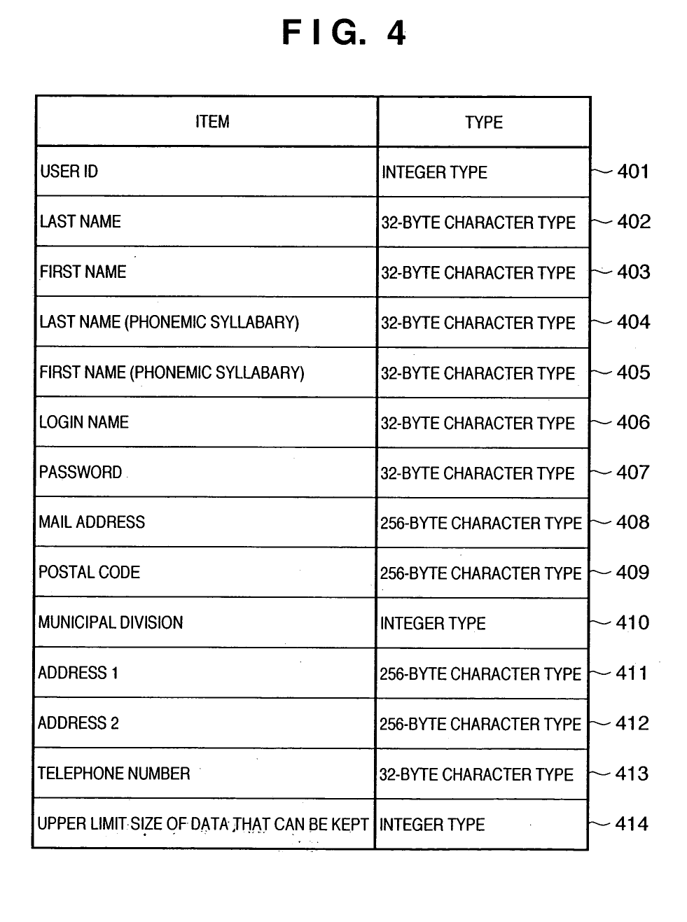

FIG. 4 is a view showing a user information table 400 stored in the information DB 118 of the photo site 105 in this embodiment.

The user information table 400 keeps a user ID 401, a user name (402 to 405), a login name 406, a password 407, a notification mail address 408 for the user, a user address (409 to 412), a telephone number 413, and an upper limit size 414 of data that can be kept.

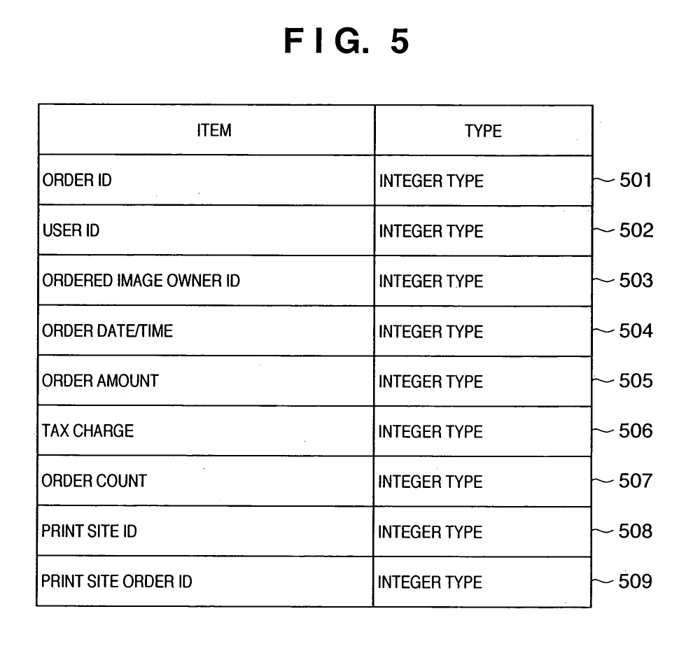

FIG. 5 is a view showing a billing information table 500 stored in the information DB 118 of the photo site 105 in this embodiment. In the billing information table, a new record is created every time a user places a print order.

The billing information table 500 keeps an order ID 501, a user ID 502 of a user who has placed the order, an ordered image owner ID 503, an order date/time 504, an order amount 505, a tax charge 506, an order count 507, a site ID 508 of a print site which has executed the order, and an order ID 509 on the print site.

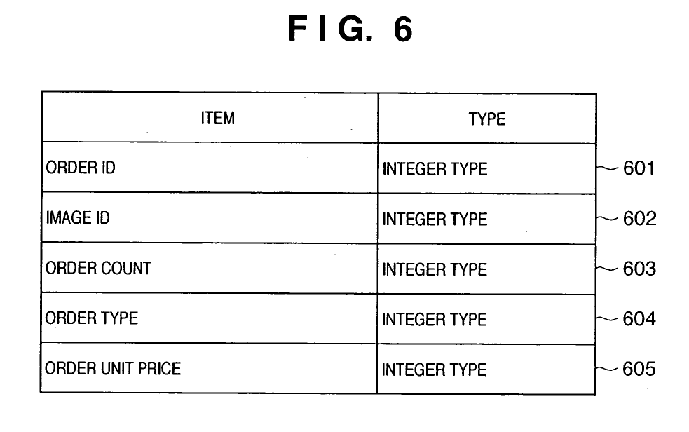

FIG. 6 is a view showing an order information table 600 stored in the information DB 118 of the photo site 105 in this embodiment. In the order information table, a new record is created for each ordered image every time a user places a print order.

The order information table 600 keeps an order ID 601, an image ID 602 of an image for which the order has been placed, an order count 603 of images, an order type 604, and an order unit price 605. In this case, as the order type 604, a numerical value corresponding to the type of service for a print order is kept. For example, 1 is kept for an L-size print; and 2, for an A4-size print.

<Example of Operation of Photo Site in Information Providing System of Embodiment>

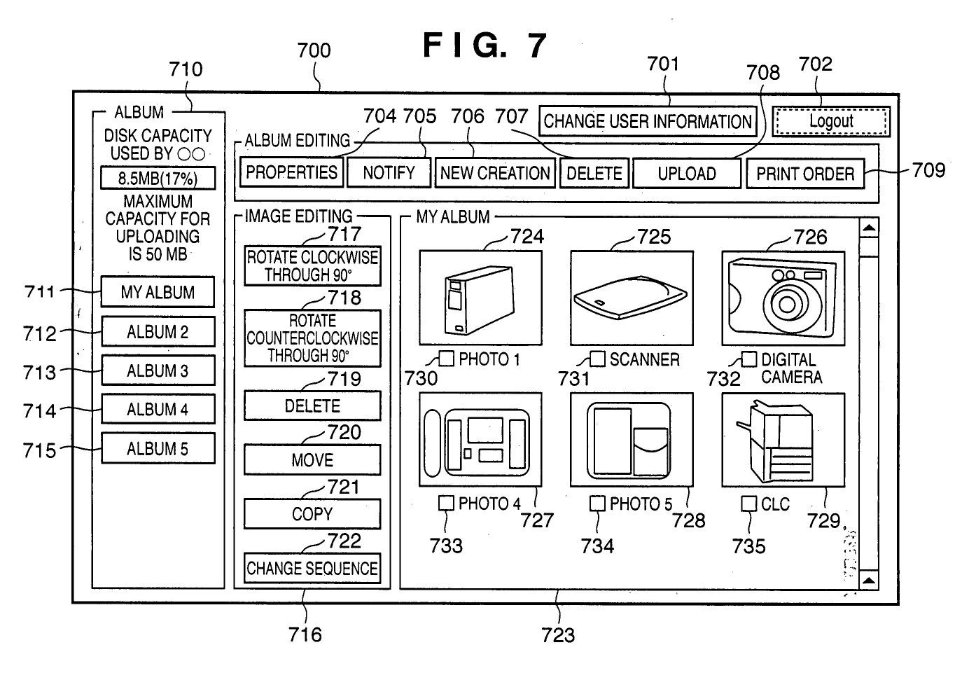

FIG. 7 is a view showing an album editing window 700 which is displayed on a user terminal when the user logs in to a photo site in this embodiment.

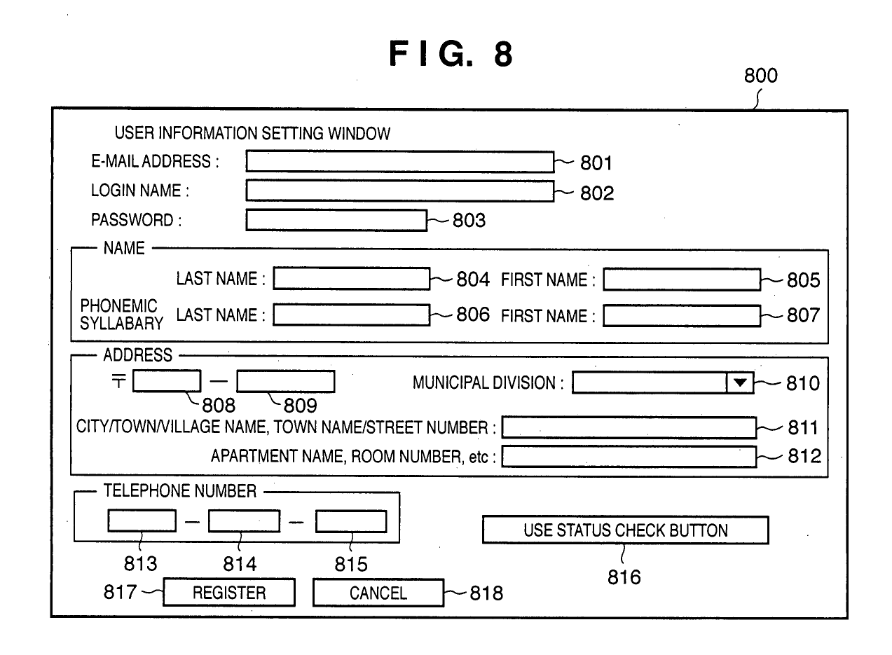

In the window 700, a button 701 is used to change user information. When the button 701 is pressed, a user information setting window 800 in FIG. 8 to be described below is displayed. A button 702 is a logout button. In an area 703, buttons for editing operation with respect to an album displayed in this window are arranged. A button 704 is a button for setting the properties of an album. A button 705 is an album notification button.

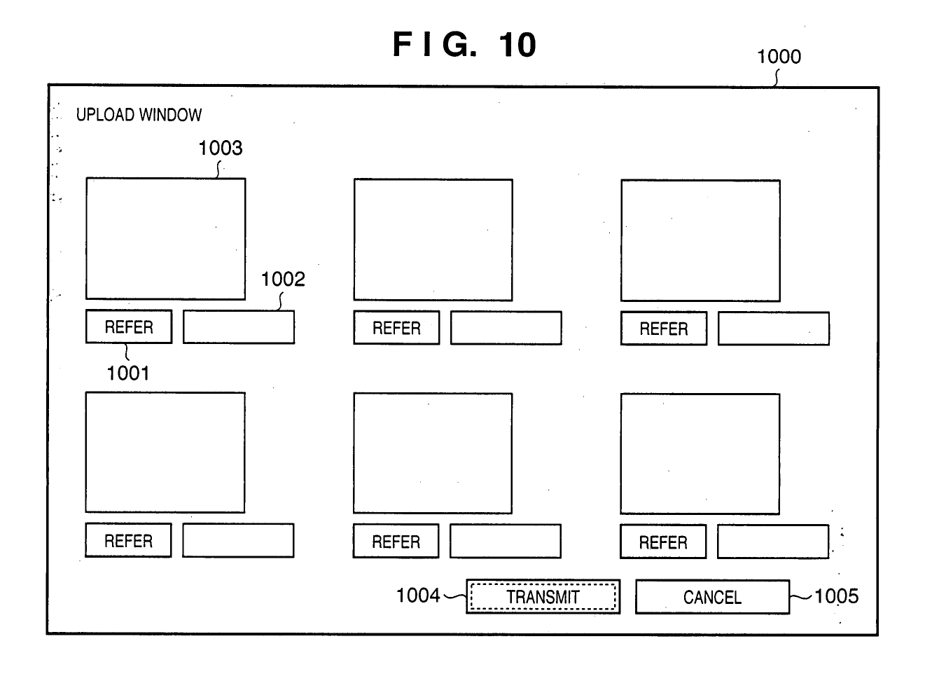

A button 706 is a button for newly creating an album. A button 707 is a button for deleting an album. A button 708 is a button for uploading an image. When the button 708 is pressed, an image upload window 1000 shown in FIG. 10 to be described below is displayed.

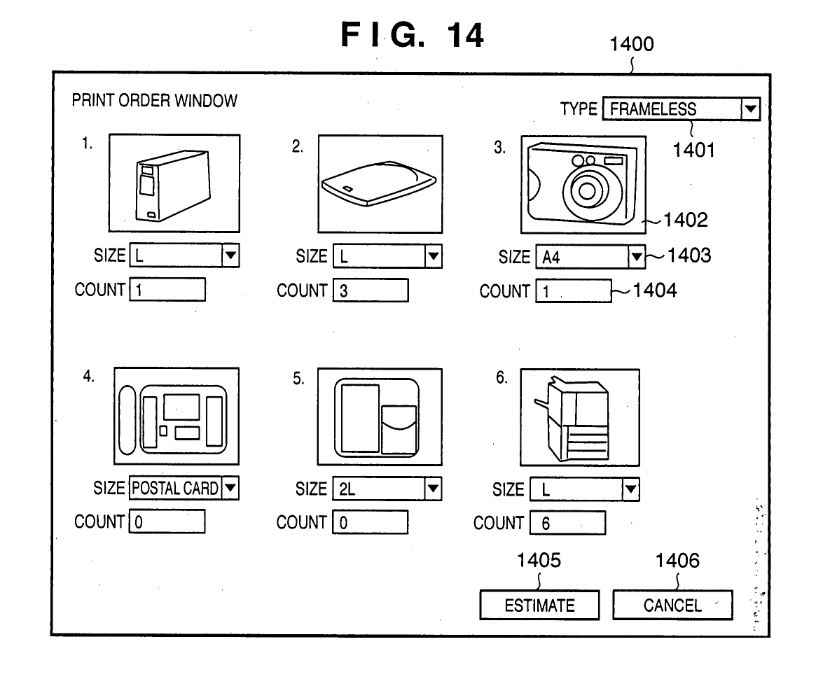

A button 709 is a print order button. When the print order button is pressed, a print order window 1400 shown in FIG. 14 is displayed, and a detail window for print information about an image corresponding to one of check boxes 730 to 735 which is checked is displayed, thereby allowing the user to place a print order.

An area 710 is an area where buttons for album selection are displayed. In the head portion of this area, the size of image data kept on the photo site by the user, the ratio of the size to the maximum disk capacity, and the maximum disk capacity are displayed. In the area below the hear portion, buttons equal in number to the albums created by the user are arranged. Referring to FIG. 7, it can be recognized from buttons 711 to 715 that the user has created five albums. When one of these buttons is pressed, the photo site 105 changes the images displayed in an album display area 723 in accordance with the selected album, and displays the album name of the selected album on the upper left end of the album display area.

An area 716 is an area where buttons for editing each image in the album are arranged. When each of buttons 717 to 722 is pressed, editing processing corresponding to the pressed button is performed for an image corresponding to one of the check boxes corresponding to the respective images displayed in the album display area 723 which is checked.

The album display area 723 is the display area for album images. In this area, the images contained in an album are sequentially displayed, and check boxes corresponding to the images are arranged. When each image is pressed, a property setting window for the image is displayed.

(Example of Displaying Upper Limit of Amount of Data That Can Be Kept in Embodiment)

FIG. 8 is a view showing an example of a user information setting window 800 for a user terminal in the photo site 105 in this embodiment, which is displayed when the user information change button 701 in FIG. 7 is pressed. The user information setting window 800 is also a window to be displayed when user registration is newly performed in the photo site 105.

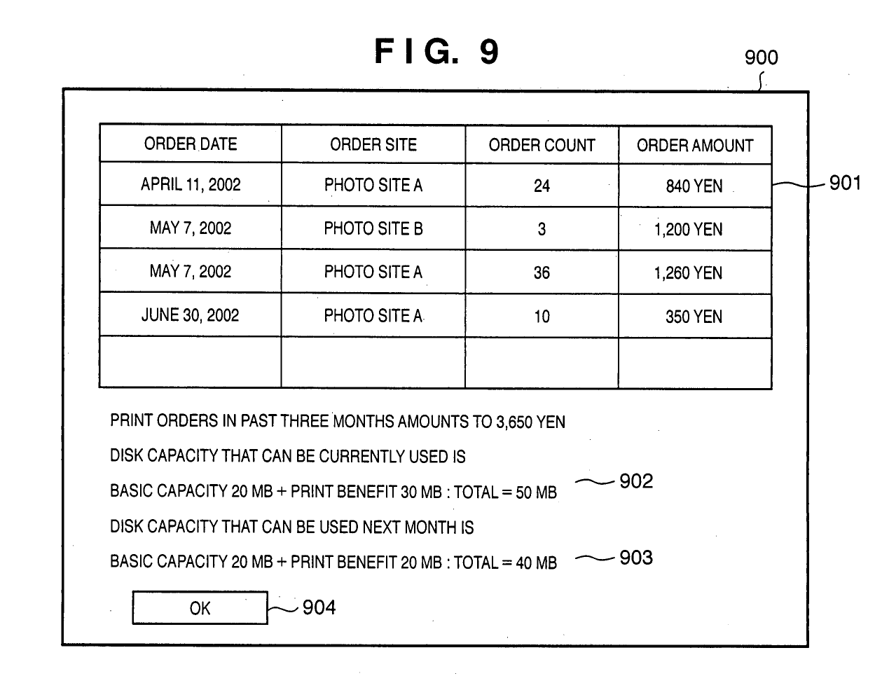

When a registration button 817 is pressed in the user information setting window 800, the information input to an E-Mail address 801 is set in the mail address 408 in the user information table 400; the information input to a Login Name 802, in the login name 406 in the user information table 400; the information input to a password 803, in the password 407 in the user information table 400; the information input to name input fields 804 to 807, in the name fields 402 to 405 in the user information table 400; the information input to postal code fields 808 and 809, in the postal code 409 in the user information table 400; the information input to a municipal division 810; in the municipal division 410 in the user information table 400; the information input to address input fields 811 and 812, in the address fields 411 and 412 in the user information table 400; and the information input to telephone number fields 813, 814, and 815, in the telephone number 413 in the user information table 400. When a use status check button 816 is pressed, a use status check window 900 shown in FIG. 9 is displayed.

FIG. 9 is a view showing an example of the use status check window 900 for a user terminal in the photo site 105 in this embodiment, which is displayed when the use status check button 816 in FIG. 8 is pressed.

In the use status check window 900, a print order status of the user in past three months is displayed in a list 901. In addition, the current upper limit of the disk capacity that can be used by the user which is calculated from the use status is displayed in an area 902; and the estimated value of the upper limit of the disk capacity that can be used next month, in an area 903. When an OK button 904 is pressed, the user information setting window 800 is displayed. A method of calculating the upper limit of the disk capacity that can be used will be described later. In this embodiment, the upper limit of the disk capacity that can be used is set monthly from a print order status in past three months. Obviously, however, these periods need not be fixed, and arbitrary periods can be set.

(Example of Image Uploading Processing in Embodiment)

FIG. 10 shows the upload window 1000 displayed when the “upload” button 708 in FIG. 7 is pressed in this embodiment. When a given image is selected and a send button 1004 is pressed on a user PC 102, the selected image is transmitted to the photo site 105 through the Internet 104. The transmitted image is registered in the currently selected album. The image information table 200 is created for each registered image, and a creation date/time 208 is initialized to the date/time when the image was registered.

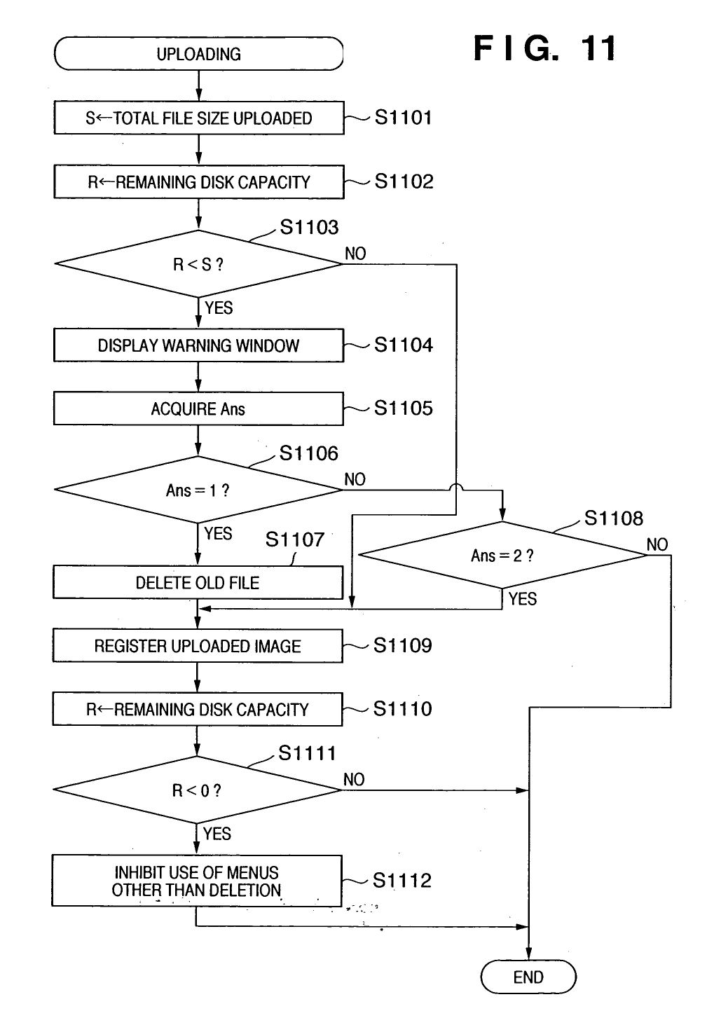

FIG. 11 is a flow chart showing an upload processing sequence to be performed in the photo site 105 when the send button 1004 is pressed in this embodiment.

In step S1101, the total file size of uploaded images is obtained and assigned to S.

In step S1102, the remaining disk capacity that can be used by the user who is to currently perform uploading operation is calculated and assigned to R. In obtaining the remaining disk capacity R, the user information table 400 is searched for a record having the user ID of the user who is to currently perform uploading operation in the user ID 401, and the upper limit size 414 of data that can be kept is obtained from the record. The album information table 300 is then searched for all the album IDs 301 having the user ID 302. The image information table 200 is searched for all images having the found album IDs in the album IDs 202. All the original file sizes of the images are added, and the sum is subtracted from the upper limit size 414 of data that can be kept which was obtained before, thereby obtaining a remaining disk capacity.

In step S1103, the remaining disk capacity R is compared with a total file size S of uploaded data.

If it is determined in step S1103 that R<S, a warning window 1200 is displayed in step S1104.

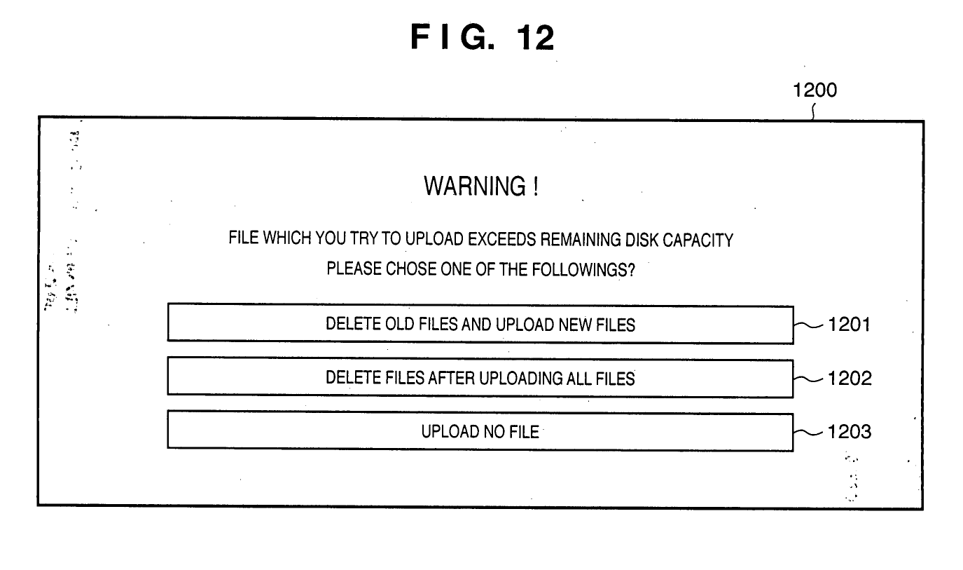

FIG. 12 shows the warning window 1200 to be displayed when the user tries to register image data exceeding the maximum disk size in image uploading operation in the photo site 105 in this embodiment.

In step S1105, a return value Ans is acquired from the warning window 1200. When a button 1201 is pressed, Ans is set to “1” When a button 1202 is pressed, Ans is set to “2”. When a button 1203 is pressed, Ans is set to “3”.

It is checked in step S1106 whether Ans is “1”. If Ans is “1”, old file deletion processing is performed in step S1107. That is, user images are searched out and sequentially deleted in chronological order until R becomes equal to or larger than S. In this case, a few criteria by which to determine whether a given file is old will be presented. However, the present invention is not limited to them. First of all, a keeping period can be used as a criterion. That is, files are deleted in the chronological order based on the creation date/time 208 in FIG. 2. However, creation dates/times do not often correspond to images which the user wants to continuously keep. In such a case, for example, in a print order system like the one described in this embodiment, files may be deleted in the chronological order based on the latest print orders (order date/time 209 in FIG. 2). In a system which provides not only print services but also other access services, files are preferably deleted in the chronological order based on the latest dates/times of accesses including accesses for browsing (access date/time 210 in FIG. 2). That is, different criteria by which to determine whether a given file is old should be used depending on which data keeping service businesses are established.

It is checked in step S1108 whether Ans is “2”. If Ans is “2”, the flow advances to step S1109. Otherwise, the processing is terminated without execution of uploading processing.

In step S1109, an uploaded image is registered. In image registration processing, one record is created in the image information table 200 for each image, and the current time is set in the date/time 208, thus registering the record in the information DB 118.

In step S1110, the remaining disk capacity R is calculated again. The same calculation method as that in step S1102 is used.

It is checked in step S1111 whether R is a negative value. When R is a negative value, it indicates that the total size of images kept by the user has already exceeded the upper limit of the disk capacity that can be used by the user.

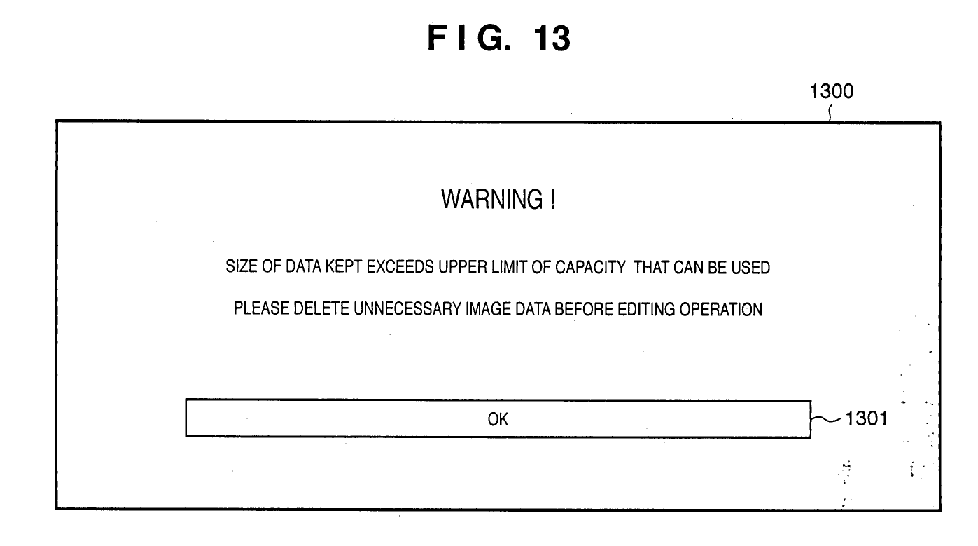

If R is a negative value, the editing menus other than deletion in the album editing window 700 are inhibited in step S1112, and the processing is terminated. That is, in the album editing area 703, the following buttons are grayed out: the property button 704, notification button 705, new creation button 706, upload button 708, and print order button 709. In addition, in the image editing area 716, the following buttons are grayed out: the clockwise rotation button 717, counterclockwise rotation button 718, move button 720, copy button 721, and sequence change button 722. Note that this system may be designed to display a warning window 1300 shown in FIG. 13 when one of the above buttons is pressed, instead of graying out them.

Referring to FIG. 11, in particular, if it is determined in step S1103 that R<S, and Ans=2 is selected in step S1108, image data is uploaded first in step S1109, and the user is then prompted to delete files in step S1112 after uploading/keeping operation.

FIG. 13 shows the warning window 1300 to be displayed when the user, who has kept image data exceeding the upper limit of the disk capacity that can be used in the photo site 105, tries to perform operation other than deletion in this embodiment.

When an OK button 1301 is pressed in the warning window 1300, the album editing window 700 is displayed.

With the above processing, image data can be uploaded. In this embodiment, the photo site 105 performs all the processing after the send button 1004 is pressed in the upload window 1000. If, however, the remaining disk capacity R on the server is transferred to the client PC 102, the client PC 102 can perform the processing from step S1101 to S1106.

(Example of Processing Image Print Order in Embodiment)

FIG. 14 shows a print order window 1400 in the print site 109A in this embodiment. When the user checks a check box corresponding to an image for which the user wants to place a print order in a photo album window indicated by the window 700, presses the button 709, a window (not shown) for the selection of a print site which is to print an image is displayed, and a print order window display request is notified to the selected print site (the print site 109A in this case).

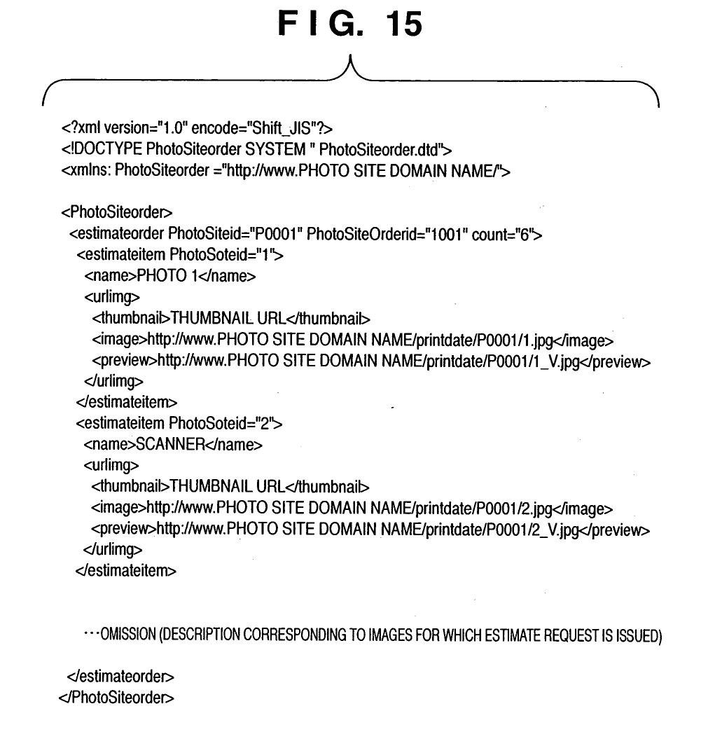

FIG. 15 shows an example of the format of data to be transmitted at the time of notification. The print site 109A displays the print order window 1400 in accordance with the information notified from the photo site 105.

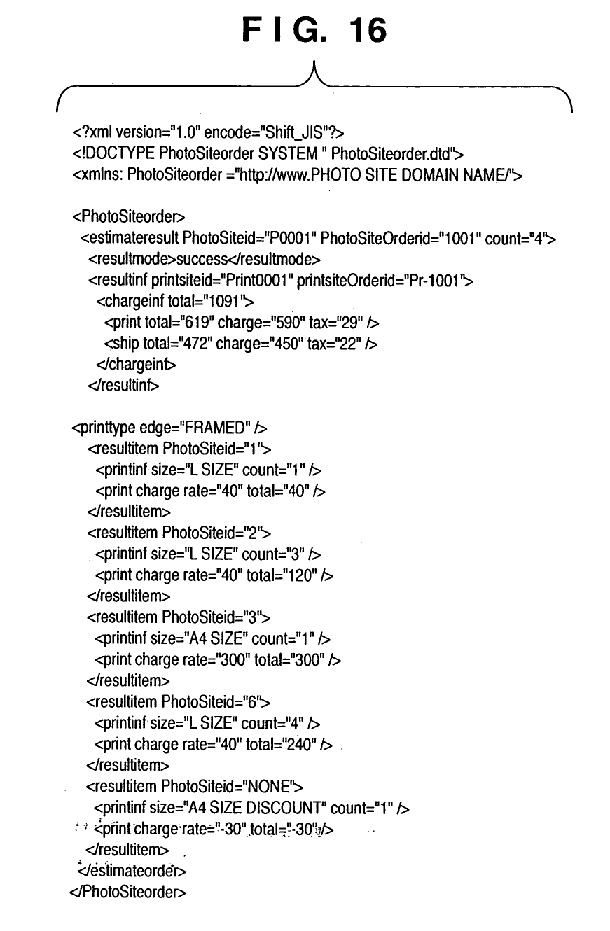

In the print order window, the user can designate an order type 1401, an order size 1403 of each image, and an order count 1404. When an estimation button 1405 is pressed, the print site 109A notifies the photo site 105 of the estimation display request information shown in FIG. 16. When a cancel button 1406 is pressed, information indicating that the order has been canceled is notified to the photo site 105. The photo site 105 then displays the window 700. In this embodiment, the user can select a framed print or frameless print as an order type. However, the user may also be allowed to select a paper type and the like.

When the print site 109A notifies the photo site 105 of an estimation display request, the photo site 105 inputs/sets orderer information and an address for delivery, and displays an estimation window. When the user gives an approval to this estimate, settlement processing is finally performed to transmit the order information to the print site 109A.

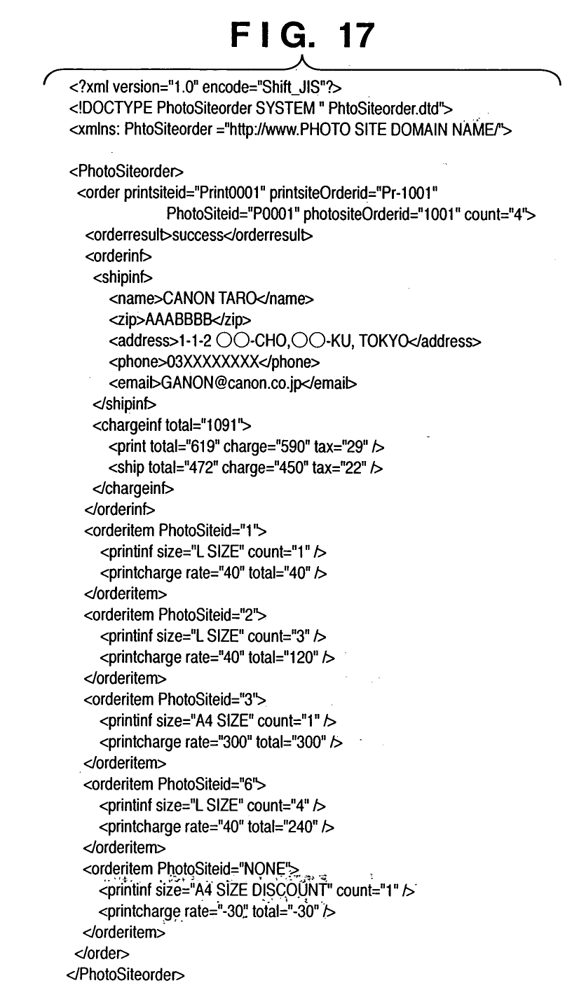

FIG. 17 shows an example of information notified from the photo site 105 to the print site 109A in the process of order processing. The print site 109A performs printing and delivery processing of a digital image on the basis of this information.

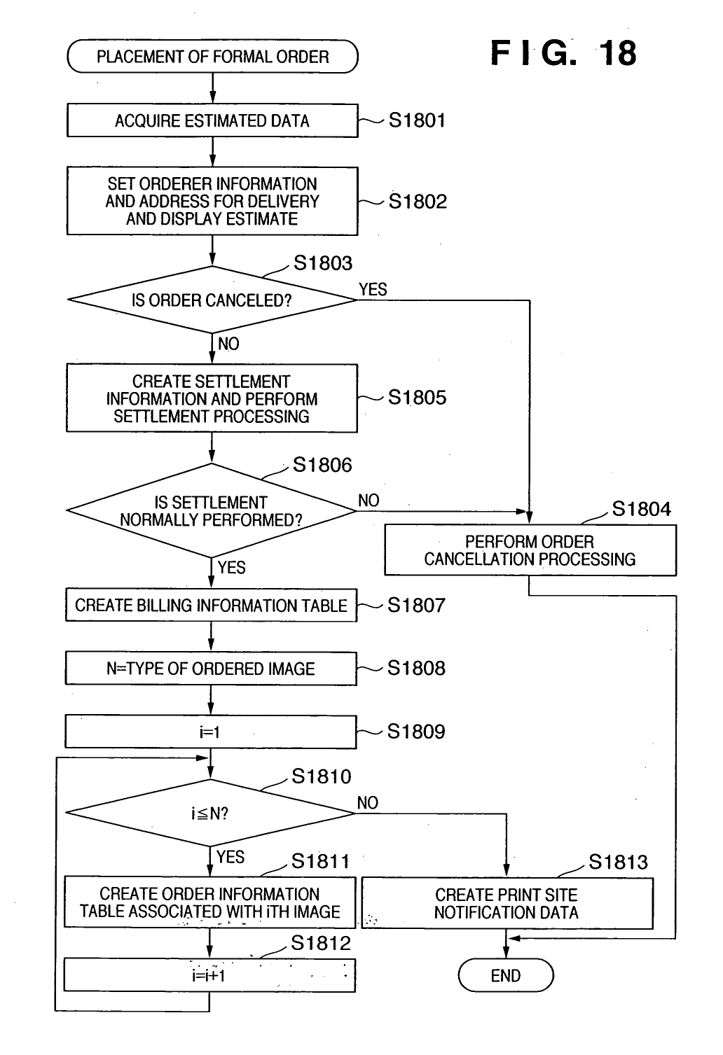

FIG. 18 is a flow chart showing a processing sequence to be executed when the photo site 105 issues formal order information upon reception of the estimation request in this embodiment.

In step S1801, the photo site 105 acquires estimation information necessary for the print order notified from the print site 109A.

In step S1802, the photo site 105 inputs various kinds of information necessary for the print order, e.g., order information and information about an address for delivery, and displays an estimate. A detailed description of these processes will be omitted.

In step S1803, the photo site 105 checks whether the user has canceled the order in the process of performing the processing in step S1802. If the user has canceled the print order, order cancellation processing is performed in step S1804, the processing is terminated. A detailed description of the order cancellation processing will be omitted.

If it is determined in step S1803 that the order has not canceled, settlement information is created in step S1805, and settlement processing is performed. A detailed description of the settlement processing will also be omitted.

In step S1806, it is checked whether the settlement processing is normally performed. If the user cancels the settlement, or the settlement processing is not normally performed, order cancellation processing is performed in step S1804, and the processing is terminated.

If it is determined in step S1806 that the settlement processing is normally completed, a new record is created in the billing information table 500 corresponding to the current print order in step S1807. The order ID 501 is a number that can uniquely define the current order on the photo site 105 and is created by the photo site 105. The user ID 502 is the user ID of the user who has placed the print order. If a browse user notified to the photo site 105 by e-mail by the album owner places a print order, 0 is set in the user ID 502. In this case, the user ID of the album owner is set in the ordered image owner ID 503. The current time acquired by using a timepiece function 201 is set in the order date/time 504. The order amount 505, tax charge 506, order count 507, print site ID 508, and print site order ID 509 are acquired from the information shown in FIG. 16 which is notified from the print site 109A to the photo site 105, and are set.

In step S1808, a type N of image necessary for the current order is acquired from the information notified from the print site 109A to the photo site 105.

In step S1809, a processing variable i indicating the number of types of images is initialized to “1”.

It is checked in step S1810 whether i is equal to or less than N. While i is equal to or less than N, the processing in steps S1811 and S1812 is continued.

In step S1811, a record in the order information table 600 which is associated with the ith image is created. In this case, the order ID 601 is equal in value to the order ID 501 contained in the record in the billing information table created in step S1807. The image ID 602 is equal in value to the image ID 201 set in the record associated with the ordered image in the image information table 200. The order count 603, order type 604, and order unit price 605 are acquired from the information shown in FIG. 16 which is notified from the print site 109A to the photo site 105, and are set.

In step S1812, 1 is added to i.

If it is determined in step S1810 that i is more than N, order information notification data for the print site 109A is created in step S1813, and the processing is terminated.

In this case, if order date/time information is used as a criterion for the selection of old files, the order date/time 209 in FIG. 2 is updated to the current order date/time when a billing information table is created in step S1807.

(Example of Calculating Upper Limit of Disk Capacity That Can Be Used In Embodiment)

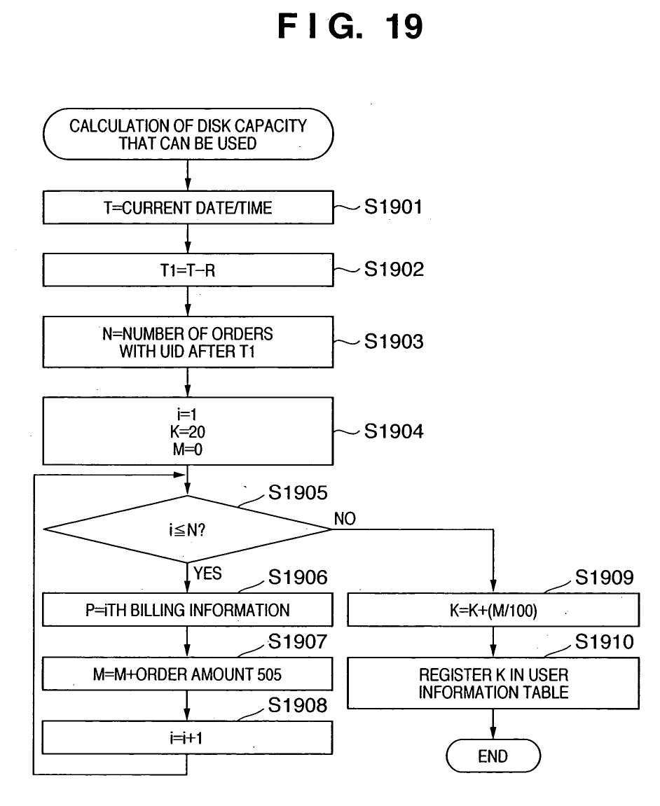

FIG. 19 is a flow chart showing a sequence for calculating the maximum disk capacity that can be used for keeping image data for each user in the photo site 105 in this embodiment.

The remaining disk capacity is periodically, e.g., monthly, calculated for each user, and set in the database.

In step S1901, a current date/time T is acquired.

In step S1902, an interval T1 is acquired by subtracting a predetermined interval from the current time T. In this embodiment, as indicated by the use status check window shown in FIG. 9 as well, a remaining disk capacity corresponding to three months is set to R as the current remaining disk capacity, and a remaining disk capacity is calculated from the set value. A remaining disk capacity corresponding to two months is set to R, and a disk use status from the next month is calculated.

In step S1903, the billing information tables 500 are searched for billing information tables, of the records having the user ID for which the remaining disk capacity is to be currently calculated, which correspond to orders placed after T1. Assume that the number of such records is N.

In step S1904, a processing variable i indicating the number of billing information table records is initialized to “1”. In addition, a processing variable K for obtaining the remaining capacity of the disk of the user is initialized to 20, and a processing variable M for obtaining the total order amount for the user is initialized to 0. The initial value K represents the initial value of the disk size that can be used when the user has placed no print order.

It is checked in step S1905 whether i is equal to or less than N. While i is equal to or less than N, the processing in step S1905 to step S1918 is repeated.

In step S1906, ith billing information is acquired from the billing information table 500.

In step S1907, the order amount 505 acquired from the billing information table 500 is added to M.

In step S1908, i is incremented by one.

If it is determined in step S1905 that i is not equal to or less than N, the quotient obtained by dividing M by 100 is added to K. K is the remaining disk capacity that can be used, which should be obtained. For the sake of convenience, the quotient obtained by dividing M by 100 is used. Obviously, however, this ratio can be changed depending on the use status of the photo site or the like.

In step S1910, K is registered in the upper limit size 414 of data that can be kept in the user information table 400.

The above processing makes it possible to automatically control the disk capacity that can be used by the user, in accordance with the print order amount within a predetermined interval.

In the above case, since the system of this embodiment is designed to provide mainly print services and bill the user for them, the upper limit of the disk capacity that can be used is calculated on the basis of the amount billed for a print order. Obviously, however, the criterion for the calculation of the upper limit of the disk capacity that can be used changes depending on which service the system mainly provides.

In the above case, the upper limit of the disk capacity that can be used is updated once monthly. However, this update operation may be performed when a new data is kept or kept data is accessed.

In this embodiment, the remaining disk capacity that can be used can be calculated by the above processing. In this case, the total size of images currently registered by each user may be calculated. For a user who has already registered image data exceeding the maximum disk capacity that can be used, a message or the like may be sent to the user by e-mail to notify him/her of the corresponding information.

When the upper limit of the disk capacity that can be used by each user is calculated once monthly, the upper limit of the disk capacity that can be used by some user may decrease. In such a case, the capacity of image data kept may automatically exceed the upper limit of the disk capacity that can be used even if the user performs no uploading processing. For this reason, the photo site 105 in this embodiment checks the remaining disk capacity that can be used when the user accesses (logs in to) the photo site.

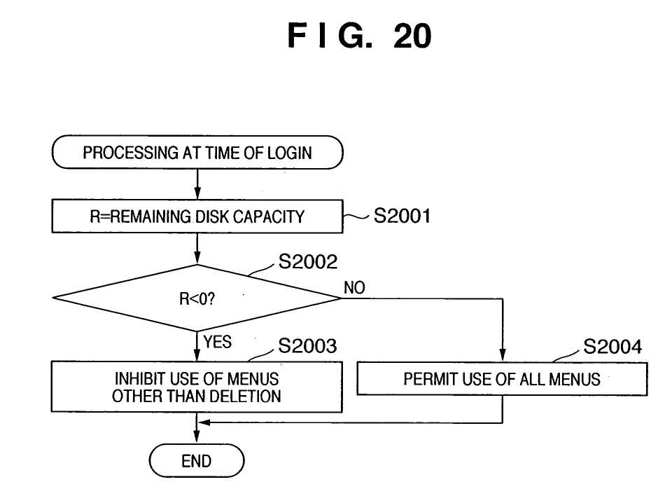

FIG. 20 is a flow chart showing a sequence at the time of logging in to a photo site in this embodiment.

In step S2001, the remaining capacity R of the disk of the user is obtained. The remaining capacity R is calculated by the same method as that described with reference to step S1102.

It is checked in step S2002 whether R is a negative value. If R is a negative value, it indicates that the total size of images kept by the user has already exceeded the upper limit of the disk capacity that can be used by the user.

If R is a negative value, the editing menus other than deletion in the album editing window 700 are inhibited in step S2103, and the processing is terminated. This processing is the same as that in step S1112. If R is not a negative value, all the editing menus in the album editing window 700 are permitted to be used in step S2104.

Assume that when an image or album is deleted while menus other than deletion are inhibited, and the same determination processing as that shown in FIG. 20 is performed to determine that the size of image data kept becomes equal to or less than the upper limit of the disk capacity that can be used. In this case, editing menus other than deletion are permitted to be used.

In this embodiment, the upper limit of a disk itself is defined as a disk size. However, the upper limit may be defined as the number of images that can be uploaded.

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code itself installed in the computer also implements the present invention. In other words, the claims of the present invention also cover a computer program for the purpose of implementing the functions of the present invention.

In this case, so long as the system or apparatus has the functions of the program, the program may be executed in any form, e.g., as object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

Further, it is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Furthermore, besides the case where the aforesaid functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

What is claimed is:

1. A method of keeping data in a data keeping service of keeping data in an information processing apparatus connected to a network, comprising the steps of:
setting an upper limit of the amount of data that can be kept in a first storage area; and
indicating a user to delete kept data after the apparatus has kept new data in a second storage area, in accordance with a result of comparison between said upper limit of the amount of data with a sum of a data amount of data kept in the first storage area and a data amount of the new data.

2. The method according to claim 1, wherein said indication step includes the steps of providing the user with a plurality of choices including deletion of kept data by a data amount exceeding the upper limit after keeping the new data, and inhibiting the user from performing operations other than data deletion when indicating the user to delete kept data by the amount exceeding the upper limit after keeping the new data.

3. The method according to claim 2, wherein said plurality of choices include keeping data after deleting at least an old file in the data amount of the new data to be kept, and stopping keeping data.

4. The method according to claim 3, wherein said old file is selected on the basis of a creation date/time or access date/time.

5. The method according to claim 1, wherein said upper limit of the amount of data is set periodically or when new data is kept or kept data is accessed.

6. The method according to claim 1, wherein said upper limit of the amount of data is set in accordance with an amount billed for the use of the data keeping service and an associated service.

7. The method according to claim 6, wherein the associated service includes printing processing of the kept data.

8. The method according to claim 1, wherein the kept data includes image data.

9. An information processing apparatus which keeps data from an entity connected to a network into a storage area, comprising:
an upper limit amount setting unit adapted to set an upper limit of the amount of data that can be kept for the entity;
a discrimination unit adapted to discriminate whether a sum of a data amount of data from the entity that has already kept and a data amount of data from the entity to be newly kept exceeds said upper limit of the amount of data; and
a deletion indication unit adapted to, when a discrimination result indicates that the sum exceeds the upper limit of the amount of data, indicate the entity to delete kept data by a data amount exceeding said upper limit after the apparatus has kept the new data.

10. A control method for an information processing apparatus which keeps data from an entity connected to a network into a storage area, comprising the steps of:
setting an upper limit of the amount of data that can be kept for the entity;
discriminating whether a sum of a data amount of data from the entity that has already kept and a data amount of data from the entity to be newly kept exceeds said upper limit of the amount of data; and
indicating the entity to delete kept data by a data amount exceeding the upper limit after the apparatus has kept the new data, when a discrimination result indicates that the sum exceeds said upper limit of the amount of data.

11. A control program for an information processing apparatus which keeps data from an entity connected to a network into a storage area, comprising:
setting an upper limit of the amount of data that can be kept for the entity;
discriminating whether a sum of a data amount of data from the entity that has already kept and a data amount of data from the entity to be newly kept exceeds said upper limit of the amount of data; and indicating the entity to delete kept data by a data amount exceeding the upper limit after the apparatus has kept the new data, when a discrimination result indicates that the sum exceeds said upper limit of the amount of data.

12. An information processing apparatus which is connected via a network to a server keeping data into a storage area, comprising:
an upper limit amount receiving unit adapted to receive an upper limit of the amount of data that can be kept;
a discrimination unit adapted to discriminate whether a sum of a data amount of data that has already kept and a data amount of data to be newly kept exceeds said upper limit of the amount of data;
a choice providing unit adapted to provide a plurality of choices including deleting kept data by a data amount exceeding said upper limit after the apparatus has kept the new data, when a discrimination result indicates that the sum exceeds said upper limit of the amount of data; and
an inhibiting unit adapted to inhibit performing operation other than data deletion, when the apparatus indicates to delete kept data by a data amount exceeding said upper limit after the apparatus has kept the new data.

13. A control method for an information processing apparatus which is connected via a network to a server keeping data into a storage area, comprising the steps of:
receiving an upper limit of the amount of data that can be kept;
discriminating whether a sum of a data amount of data that has already kept and a data amount of data to be newly kept exceeds said upper limit of the amount of data;
providing a plurality of choices including deleting kept data by a data amount exceeding said upper limit after the apparatus has kept new data, when a discrimination result indicates that the sum exceeds the upper limit of the amount of data; and
inhibiting performing operation other than data deletion when the apparatus indicates to delete kept data by a data amount exceeding said upper limit after the apparatus has kept the new data.

14. A control program for an information processing apparatus which is connected via a network to a server keeping data into a storage area, comprising:
receiving an upper limit of the amount of data that can be kept;
discriminating whether a sum of a data amount of data that has already kept and a data amount of data to be newly kept exceeds said upper limit of the amount of data;
providing a plurality of choices including deleting kept data by a data amount exceeding said upper limit after the apparatus has kept new data, when a discrimination result indicates that the sum exceeds the upper limit of the amount of data; and
inhibiting performing operation other than data deletion when the apparatus indicates to delete kept data by a data amount exceeding said upper limit after the apparatus has kept the new data.
